(19) United States
(12) Patent Application Publication
(10) Pub. No.: US 2014/0204289 A1
(43) Pub. Date: Jul. 24, 2014

(54) ELECTRONIC DEVICE

(71) Applicant: HON HAI PRECISION INDUSTRY CO., LTD., New Taipei (TW)

(72) Inventor: SHAO-HAN CHANG, New Taipei (TW)

(73) Assignee: HON HAI PRECISION INDUSTRY CO., LTD., New Taipei (TW)

(21) Appl. No.: 14/153,085

(22) Filed: Jan. 13, 2014

(30) Foreign Application Priority Data
Jan. 22, 2013 (CN) 2013100225212

(51) Int. Cl. F21V 8/00

(52) U.S. Cl. CPC G02B 6/0081
USPC 349/12; 362/606; 362/607; 362/611

(57) ABSTRACT

An electronic device includes a housing, a metallic support plate, a mounting frame, and a backlight module. The housing includes a side frame, and a mounting frame mounted on the side frame. The metallic support plate is received in the side frame. The backlight module includes a light source mounted on the metallic support plate, and a light guide plate mounted on the metallic support plate. The light guide plate is located between the metallic support plate and the mounting frame.

### BACKGROUND

1. Technical Field

The present disclosure relates to electronic devices, particularly to an electronic device including a display module.

2. Description of Related Art

In assembly of an electronic device equipped with a display module, such as a mobile phone for example, a touch panel, a display panel, and a backlight unit are laminated together to be an integral display module, and then the integral display module is put into a housing of the electronic device. Then, LED lights are directly mounted in the housing. However, heat produced by the LED lights usually cannot be dissipated effectively, especially considering that the housing is made of plastic. Thus, a poor luminous efficiency of the LED lights is thereby achieved.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a front view of an embodiment of an electronic device.

FIG. 2 is an exploded, isometric view of the electronic device shown in FIG. 1.

FIG. 3 is a partial, isometric view of the electronic device shown in FIG. 2.

FIG. 4 is a sectional view along a line IV-IV of the electronic device shown in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

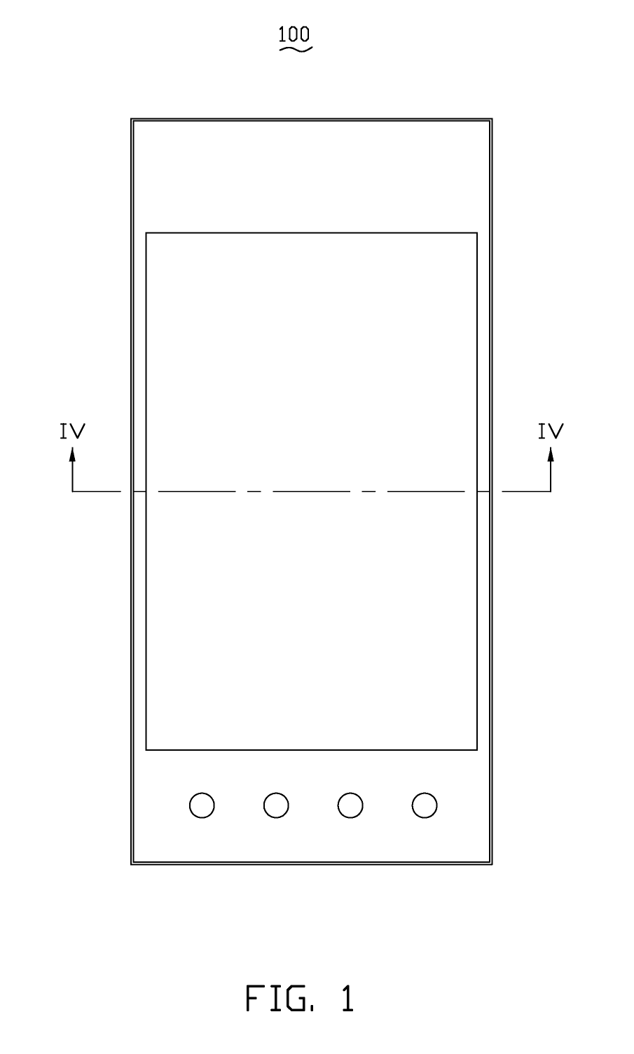

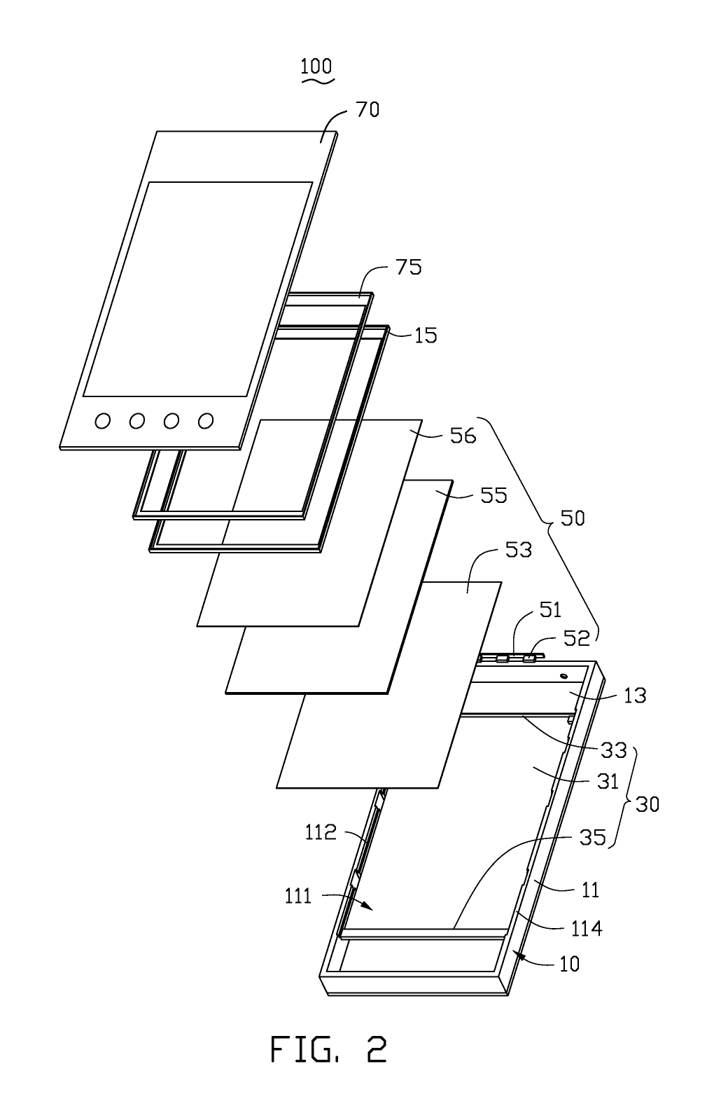

FIGS. 1 and 2 show an embodiment of an electronic device 100 including a housing 10, a metallic support plate 30 mounted in the housing 10, a backlight module 50, and a display module 70. The metallic support plate 30 is configured to support the backlight module 50. In the illustrated embodiment, the electronic device 100 is a touch screen mobile phone.

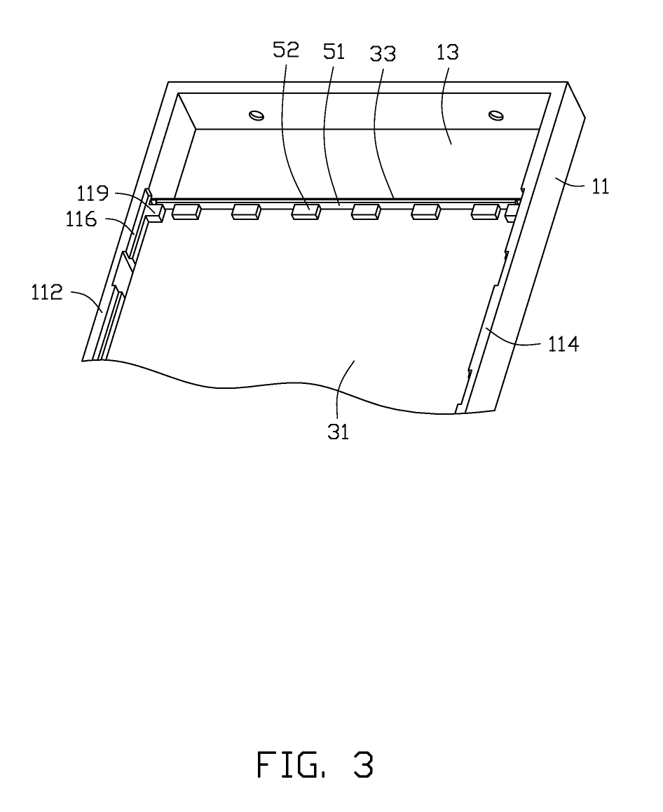

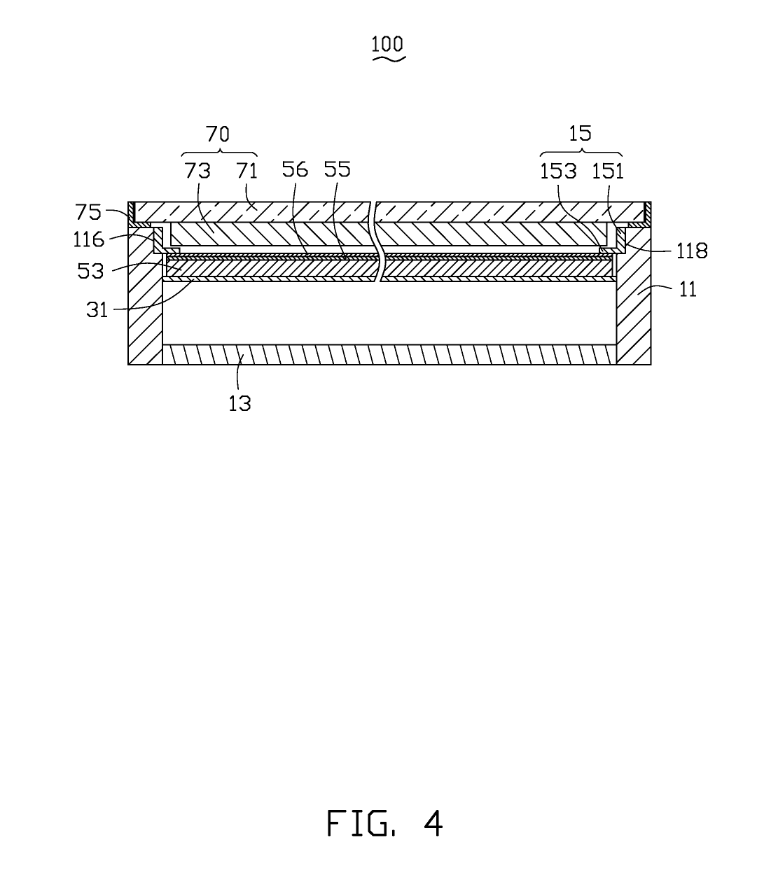

The housing 10 includes a side frame 11, a cover 13 and a mounting frame 15 mounted on opposite sides of the side frame 11, respectively. The side frame 11 and the cover 13 cooperatively define a receiving chamber 111. The side frame 11 is substantially a rectangular hollow frame, and includes a first broadside 112 and a second broadside 114 opposite to each other. The first broadside 112 and the second broadside 114 are parallel to each other, and are longer portions or sides of the rectangular side frame 11. The first broadside 112 defines a first mounting groove 116 (shown in FIGS. 3 and 4) along a longitudinal direction thereof. The second broadside 114 defines a second mounting groove 118 (shown in FIG. 4) along a longitudinal direction thereof corresponding to the first mounting groove 116. The first mounting groove 116 and the second mounting groove 118 communicate with the receiving chamber 111, for mounting the mounting frame 15. Two fixing portions 119 protrude from an inner sidewall of the first broadside 112 and an inner sidewall of the second broadside 114, respectively. One of the fixing portions 119 is located adjacent and below an end of the first mounting groove 116, and the other one of the fixing portions 119 is located adjacent and below an end of the second mounting groove 118. The two fixing portions 119 are located opposite to each other.

The cover 13 is detachably mounted at a side of the side frame 11, and a shape and a size of the cover 13 is matched with the side frame 11, to be seamlessly coupled with the side frame 11. Opposite sides of the mounting frame 15 are mounted on opposite sides of the side frame 11, respectively, and are received in the first mounting groove 116 and the second mounting groove 118, respectively, thereby mounting the mounting frame 15 on the housing 10. A cross-section of the mounting frame 15 is substantially L-shaped. The mounting frame 15 includes a base frame 151 and an extending portion 153 extending from the base frame 151. The base frame 151 is substantially rectangular and hollow, and the extending portion 153 extends from an inner sidewall of the base frame 151 toward a center region of the base frame 151. The extending portion 153 is substantially rectangular hollow frame. Both of the base frame 151 and the extending portion 153 are mounted in the first mounting groove 116 and the second mounting groove 118, and the protruding portion 153 is partially received in the receiving chamber 111. The mounting frame 15 is made of flexible materials, and is deformable. In the illustrated embodiment, the side frame 11 and the cover 13 are made of metal. The mounting frame 15 is made of rubber.

FIGS. 2 and 3 show the metallic support plate 30 fixed on inner sidewalls of the side frame 11, and received in the receiving chamber 111. The metallic support plate 30 includes a base plate 31, a mounting portion 33, and a blocking portion 35. The mounting portion 33 and the blocking portion 35 extends from opposite ends of the base plate 31 towards a direction away from the cover 13. The mounting portion 33 is located at an end of the base plate 31 adjacent to the fixing portions 119. The blocking portion 35 is parallel to an imaginary connecting line of the fixing portions 119. A bottom surface of the metallic support plate 30 adjacent to the mounting frame 15 is coated with a high reflection film or a high reflection coating (not shown), to reflect light. In the illustrated embodiment, opposite sides of the metallic support plate 30 are welded to the inner sidewall of the first broadside 112 and the inner sidewall of the second broadside 114, and the metallic support plate 30 is located below the fixing portions 119. In an alternative embodiment, the metallic support plate 30 can be fixed with the side frame 11 using fasteners, or magnets, or glues.

FIGS. 2 to 4 show the backlight module 50. The backlight module 50 is mounted on the metallic support plate 30, and is located between the metallic support plate 30 and the mounting frame 15. The backlight module 50 includes a mounting plate 51, a plurality of light sources 52, a light guide plate 53, a first optical sheet 55, and a second optical sheet 56. The mounting plate 51 is mounted on the mounting portion 33, and is configured to support a drive circuit (not shown) for driving the light sources 52. The light sources 52 are positioned on the mounting plate 51, and are arranged apart. The light sources 52 contact with the base plate 31, so that the heat produced by the light sources 52 can be conducted and dissipated by the metallic support plate 30 and the side frame 11.

The light guide plate 53 is mounted on the base plate 31 of the metallic support plate 30, and is positioned on the base plate 31 cooperatively with the fixing portions 119 and the blocking portion 35. The light guide plate 53 is located between the fixing portions 119 and the blocking portion 35. The first optical sheet 55 and the second optical sheet 56 are laminated together, and are mounted on the light guide plate 53. The second optical sheet 56 resists against the extending portion 153 of the mounting frame 15. In the illustrated embodiment, the mounting plate 51 is made of metal. The light sources 52 are LED lights.

The display module 70 includes a touch panel 71, a display panel 73 laminated with the touch panel 71, and a fixing frame 75. An area of the display panel 73 is smaller than an area of the touch panel 71, so that edges of the touch panel 71 and the display panel 73 are substantially stepped when the touch panel 71 and the display panel 73 are assembled together. The assembled touch panel 71 and the display panel 73 are mounted on the fixing frame 75. A cross section of the fixing frame 75 is substantially L-shaped, and the touch panel 71 is supported by the fixing frame 75. A top surface of the touch panel 71 is coplanar with a top surface of the fixing frame 75. The fixing frame 75 is mounted on a top surface of the side frame 11, so that the touch panel 71 and the display panel 73 are assembled with the side frame 11. The touch panel 71 is received in the fixing frame 75. The display panel 73 faces the mounting frame 15, and is received in the receiving chamber 111. The display panel 73 resist the extending portion 153 of the mounting frame 15.

In assembly, the cover 13 is mounted at a side of the side frame 11. The metallic support plate 30 is mounted in the side frame 11. The light sources 52 are positioned on the mounting plate 51, and then the mounting plate 51 is mounted on the mounting portion 33 of the metallic support plate 30. The light guide plate 53 is mounted on the base plate 31, and latched between the fixing portions 119 and the blocking portion 35. The first optical sheet 55 and the second optical sheet 56 are laminated and mounted on the light guide plate 53. The fixing frame 15 is mounted on the first mounting groove 116 and the second mounting groove 118, and the extending portion 153 resists against the second optical sheet 56. The touch panel 71 and the display panel 73 are laminated together, and are mounted on the side frame 11 via the fixing frame 75, thereby having the touch panel 71 covering the receiving chamber 111.

Due to the light sources 52 being mounted on the mounting plate 51, and contacts with the metallic support plate 30, thus the heat dissipated from the light sources 52 is capable of conducting and dissipating from the metallic support plate 30 and the side frame 11, respectively. Because the metallic support plate 30 is coated with a reflection layer, a reflection sheet does not need to be assembled in the housing 10, thereby saving space. As a result, the backlight module 50 is efficiently assembled on the metallic support plate 30, thereby decreasing a thickness of the electronic device 100. The extending portion 153 of the mounting frame 15 is mounted in the first mounting groove 116 and the second mounting groove 118, and resists against the second optical sheet 56, thus the extending portion 153 seals a gap between the second optical sheet 56 and the side frame 11, to avoid dusts from dropping into the backlight module 50.

In an alternative embodiment, the light sources 52 can be directly mounted on the base plate 31 or the mounting portion 33, and thus the mounting plate 51 can be omitted. The second optical sheet 56 may be omitted, and then the first optical sheet 55 resists against the extending portion 153.

It is believed that the present embodiments and their advantages will be understood from the foregoing description, and it will be apparent that various changes may be made thereto without departing from the spirit and scope of the embodiments or sacrificing all of its material advantages.

What is claimed is:

1. An electronic device, comprising:
a housing comprising:
a side frame,
a cover mounted on a side of the side frame, and
a mounting frame mounted on an opposite side of the side frame away from the cover;
a metallic support plate mounted in the side frame;
a backlight module comprising:
a light source mounted on the metallic support plate,
a light guide plate mounted on the metallic support plate, and
a first optical sheet mounted on the light guide plate, the light guide plate and the first optical sheet located between the metallic support plate and the mounting frame; and
a display module mounted on the housing.

2. The electronic device of claim 1, wherein the mounting frame resists against the first optical sheet.

3. The electronic device of claim 1, wherein the side frame comprises a first broadside and a second broadside parallel to the first broadside, the first broadside defines a first mounting groove, the second broadside defines a second mounting groove, the side frame and the cover cooperatively define a receiving chamber, the first mounting groove and the second mounting groove communicate with the receiving chamber, the light source, the light guide plate, and the first optical sheet are received in the receiving chamber, the mounting frame is mounted in the first mounting groove and the second mounting groove.

4. The electronic device of claim 3, wherein the mounting frame comprises a base frame and an extending portion extending from an inner sidewall of the base frame towards a center region of the base frame, the base frame and the extending portion are receive in the first mounting groove and the second mounting groove, the extending portion is partly received in the receiving chamber, and resists against the first optical sheet.

5. The electronic device of claim 1, wherein the backlight module further comprises a second optical sheet, the second optical sheet is laminated on the first optical sheet, the mounting frame resists against the second optical sheet.

6. The electronic device of claim 1, wherein the metallic support plate comprises a base plate and a mounting portion extending from an end of the base plate adjacent to the light source, the light source is mounted on the mounting portion.

7. The electronic device of claim 6, wherein the backlight module further comprises a mounting plate, the light source is mounted on the mounting plate, the mounting plate is mounted on the mounting portion of the metallic support plate.

8. The electronic device of claim 6, wherein the metallic support plate further comprises a blocking portion extending from an end of the base plate away from the mounting portion, two protruding portions protrudes from opposite inner sidewalls of the side frame, respectively, the blocking portion is parallel to an imaginary connecting line of the two protruding portions, the light guide plate is latched between the two protruding portions and the blocking portion.

9. The electronic device of claim 1, wherein the display module comprises a touch panel, a display panel, and a fixing frame, the touch panel is laminated with the display panel, and the touch panel is mounted on the fixing frame, the fixing frame is mounted on the side frame, the display panel resists against the mounting frame.

10. The electronic device of claim 1, wherein a surface of the metallic support plate adjacent to the mounting frame is coated with a reflection layer.

11. An electronic device, comprising:
a housing comprising:
a side frame, and
a mounting frame mounted on the side frame;
a metallic support plate received in the side frame;
a backlight module comprising:
a light source mounted on the metallic support plate, and
a light guide plate mounted on the metallic support plate, and located between the metallic support plate and the mounting frame.

12. The electronic device of claim 11, wherein the backlight module further comprises at least one optical sheet located between the mounting frame and the light guide plate, the mounting frame resists against the at least one optical sheet.

13. The electronic device of claim 11, wherein the side frame comprises a first broadside and a second broadside parallel to the first broadside, the first broadside defines a first mounting groove along a longitudinal direction thereof, the second broadside defines a second mounting groove along a longitudinal direction thereof, the side frame defines a receiving chamber, the first mounting groove and the second mounting groove communicate with the receiving chamber, the light source and the light guide plate are received in the receiving chamber, the mounting frame is partly received in the first mounting groove and the second mounting groove.

14. The electronic device of claim 12, wherein the mounting frame comprises a base frame and an extending portion extending from an inner sidewall of the base frame , the base frame and the extending portion are receive in the first mounting groove and the second mounting groove, the extending portion is partly received in the receiving chamber, and resists against the at least one optical sheet.

15. The electronic device of claim 14, wherein the at least one optical sheet comprises a first optical sheet and a second optical sheet laminated on the first optical sheet, the extending portion resists against the second optical sheet.

16. The electronic device of claim 11, wherein the metallic support plate comprises a base plate and a mounting portion extending from an end of the base plate adjacent to the light source, the light source is mounted on the mounting portion.

17. The electronic device of claim 16, wherein the backlight module further comprises a mounting plate, the light source is mounted on the mounting plate, the mounting plate is mounted on the mounting portion.

18. The electronic device of claim 11, wherein the mounting frame is deformable.

19. The electronic device of claim 11 further comprising a display module, wherein the display module further comprises a touch panel, a display panel, and a fixing frame, the touch panel is laminated with the display panel, and the touch panel is mounted on the fixing frame, the fixing frame is mounted on a top surface of the side frame, the display panel resists against the mounting frame.
